(19) United States
(12) Patent Application Publication
(10) Pub. No.: US 2007/0071870 A1
(43) Pub. Date: Mar. 29, 2007

(54) Tea process

(75) Inventor: Xiaoqing You, Bedfordshire (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/525,441

(22) Filed: Sep. 22, 2006

(30) Foreign Application Priority Data
Sep. 23, 2005 (EP) EP05255941

(51) Int. Cl. A23F 3/00

(52) U.S. Cl. 426/597

(57) ABSTRACT

A process for making black or green tea with the floral aroma of oolong tea is provided. The process utilises tumbling to physically wound the leaves to initiate the oolong aromas and does not involve a traditional solar wither step.

The present invention relates to a process for making black or green tea with a floral oolong aroma.

### BACKGROUND AND PRIOR ART

Tea is generally prepared as green leaf tea or black leaf tea. The method of preparing such teas is well known to those skilled in the art. Generally, to prepare black leaf tea, fresh green leaves of the plant Camellia sinensis are withered (subjected to mild drying), comminuted, fermented (in which process enzymes in the leaf tea use atmospheric oxygen to oxidise various substrates to produce brown-coloured products) and then fired (to dry the tea leaves). Green leaf tea is not exposed to the fermentation process. Partial fermentation may be used to produce intermediate-type teas known as “oolong” tea.

Chinese oolong teas are ‘semi-fermented’ teas that are characterised, in part, by the floral nature of their aroma. It is thought that the characteristic aroma is generated, at least in part, by the specific process conditions employed, in particular, a short solar wither of the plucked leaf followed by several hours of indoor withering with gentle tumbling. The major contributors to the distinctive aroma are the monoterpene alcohols (e.g. linalool, geraniol) and the aromatic alcohols (e.g. benzyl alcohol, phenylethanol). These aromatic volatiles are produced, from glycosidic precursors, by enzymic action that is activated as a consequence of moisture loss and mechanical damage during the withering and rolling processes.

Although, in principle, any tea plant can be manufactured via an ‘oolong’ process into ‘oolong-type’ tea, certain varieties of tea clearly produce the highest quality oolong teas. Oolong teas are traditionally produced in Fujian and Taiwan provinces in China from specific var. sinensis clones within that impart the flowery aroma.

However, the global market for oolong tea remains tiny in comparison to the market for black and green tea. It is therefore desirable to provide a black and/or green tea which is enhanced with some of the aroma characteristics of oolong tea.

JP 62/115236 discloses a process for producing semi-fermented tea independently of hot weather, by passing a small amount of hot air through thinly spread raw leaves while irradiating the leaves with far-infrared radiation, collecting a prescribed amount of withered and fermented tea leaves, agitating under rotation and carrying out the roasting, rolling and forming of the tea leaves. The infrared irradiation step is said to have the same effect as subjecting the leaves to strong sunlight.

GB 593260 discloses a process of manufacturing tea, according to which picked leaf is frozen without being subjected to withering and then tumbling the frozen leaf in the presence of air at least until it has thawed, and the thawed leaf is then subjected to the normal steps of manufacture. Unfortunately, freezing of the leaf results in drastic cell damage which not only releases large amounts of water which must be removed by centrifugation, but also introduces much more wounding to the leaves than would normally be associated with tumbling.

CN 1109504 discloses a method of manufacturing an oolong black tea comprising the steps of plucking, solar withering, indoor tumbling, rolling, fermenting and drying. The tea has the infusion characteristics and colour of black tea but has enhanced floral aromas of oolong tea. The complicated and long processing results in the tea costing 5 to 8 times more than conventional black tea.

The present inventors have discovered that the critical process step in enhancing the floral aromas of tea is in the tumbling step. Thus the solar withering step may be omitted entirely, so accelerating and reducing the cost of the above described oolong black tea process. Furthermore, tumbling leaf which has not been frozen provides the necessary wounding to induce the floral aroma.

Thus in a first aspect, the present invention provides a process according to claim 1.

### DETAILED DESCRIPTION OF THE INVENTION

### Light-Induced Withering

It is essential to the invention that the process does not involve a light-induced withering step. In the traditional oolong tea process, this step, referred to as Sai-ging in Chinese, is carried out by arranging fresh tea leaves on bamboo baskets and leaving them to wither in direct sunlight for 30 to 60 minutes. Clearly the light used to cause the withering does not have to be sunlight, as it could be artificial light. The term “light” encompasses visible light as well as UV and infrared radiation.

In the traditional light-induced withering step, the temperature of the leaves increases to from 30 to 45° C., which causes the characteristic oolong fermentation process to initiate. It is conventionally believed that it is during this stage that the characteristic taste and aroma properties of oolong tea are induced. The present inventors have discovered that this is not a necessary step in inducing floral aromas in tea.

Thus, it is preferred that the leaves are tumbled at a leaf temperature of less than 40° C., more preferably less than 35° C. and most preferably less than 30° C.

### Long Wither and Tumbling

Instead of starting with solar withering, the present process starts with the long indoor wither with tumbling, a step called Yao-ging in Chinese.

The plucked tea leaves are left to wither indoors preferably for at least 2 hours. Preferably this is for more than 5 hours, even more preferably for more than 7 hours.

According to the present invention this long wither is believed to initiate the floral taste and aroma biological processes in the leaf.

During the long wither, the leaves are preferably tumbled at least once, preferably in a simple roll-cage. This has the effect of causing controlled damage to the perimeter of the leaf and is essential to obtaining good floral taste and aroma. If the damage is more extensive, for example as would be brought about by freezing the leaves, then the floral taste and aroma are lost. Thus the leaves should not be frozen prior-to or during tumbling. In particular, it is preferred that the leaf temperature during tumbling is at least 5° C., more preferably at least 10° C. and optimally at least 15° C.

Preferably the leaves are tumbled every 2 hours during the long wither. Preferably the leaves are tumbled at least twice during the long wither, even more preferably at least three times.

The tumbling need only be gentle and as such, the rotation speed of a tumbler will be less than 100 rpm, preferably less than 50 rpm. The duration of the tumbling is from 1 to 10 minutes, preferably from 2 to 7 minutes.

### Rolling

The leaf tea may be rolled after it has been withered and tumbled. This is similar to the orthodox black tea manufacture step, and is believed to increase further the floral aroma and taste characteristics due to the damage caused to the leaf and the further fermentation which occurs.

### Maceration

The leaf tea may also subsequently be macerated. One can macerate tea in many ways but broadly speaking there are two main mechanised methods for doing this.

The first, called “orthodox manufacture”, involves rolling withered tea leaves as part of a standardised procedure including fermenting and drying steps. So called “orthodox tea” is typically characterised by large leaf portions that are aesthetically pleasing to many but produce lighter liquors due to less extensive fermentation.

The second method is the most popular of a number of non-orthodox methods that involves using a machine resembling a mangle that cuts, tears and curls tea leaves. The original machine was invented by W. McKercher in 1930 and is commonly referred to a CTC (cut-tear-curl) machine. The finely cut product is known generically as “CTC tea” and is characterised by a fast infusion rate and strong colour.

Both orthodox and CTC machines are often used in conjunction with a Rotorvane machine that minces withered tea leaves. These methods and their history and role in tea manufacture are described in “Tea: cultivation to consumption” edited by K. C. Willson and M. N. Clifford, Chapman & Hall, 1992.

Generally speaking consumer preference for either orthodox or CTC tea is a matter of national or regional culture. In some countries the visual appearance and texture of leaf tea are both important indicators of quality, larger leaf particles being associated with higher quality. In Western markets tea is increasingly purchased in filter paper bags and the colour of the infused product is more important.

### Fermentation

A preferred optional step is the black tea fermentation step, but however, that is something of a misnomer. “Fermentation” is commonly used in the context of brewing alcohol to describe the action of exogenous enzymes. However in the tea world it is used to refer to the oxidative process that tea undergoes when certain endogenous enzymes and substrates are brought together by mechanical disruption of the cells by tearing or cutting the leaves. Tea and other plant material can be oxidised by the action of exogenous enzymes such as oxidases, laccases and peroxidases so for present purposes the term “fermentation” will describe enzymic oxidation regardless of the source of the enzymes responsible. The essential fermentation step is believed to provide the desirable black tea colour and flavour characteristics.

### Firing

If fermentation is employed, the tea leaves must also be subjected to a high temperature for a short period of time. This stage is called ‘firing’.

### EXAMPLES

A source of green tea leaves were plucked and brought indoors and were withered for 8 hours, being tumbled in 25 kg batches for 4 minutes every 2 hours at a rotation speed of 28 rpm. The leaves were then rolled. The resulting leaves were then passed through a conventional CTC (crush-tear-curl) machine and fermented. The fermented leaves were then fired to arrest fermentation. The resultant Oolong-black tea leaves when infused in hot water gave a black tea infusion with good colour and flavour with the floral notes of an oolong tea.

For comparison purposes the above was repeated but wherein the indoor wither was preceded by a conventional solar wither step. Additionally it was repeated without the indoor tumbling step to result in a conventional CTC black tea product.

The three types of tea, conventional CTC black tea, the oolong black tea and the non-solar wither oolong black tea of the present invention were chemically analysed and the results are shown in the table below.

| | Aroma peak area | | |
|---|---|---|---|
| | CTC black tea | Oolong | non-solar withering |
| Compounds | (control) | black tea | Oolong black tea |
| 1-penten-3-one | 10.25 | 17.19 | 16.63 |
| Hexanal | 235.39 | 425.25 | 364.26 |
| E-2-hexenal | 1680.95 | 1590.44 | 1508.78 |
| Z-4-heptenal | 9.96 | 22.75 | 5.30 |
| octen-3-one | 3.27 | 9.15 | 6.45 |
| 2-penten-1-ol | 18.90 | 41.59 | 28.08 |
| Hexanol | 6.32 | 14.46 | 10.25 |
| Z-3-hexen-1-ol | 81.71 | 110.13 | 75.62 |
| E-2-hexen-1-ol | 72.36 | 66.49 | 61.78 |
| E-2-octenal | 15.16 | 44.20 | 33.24 |
| Linalool oxide (cis) | 7.24 | 12.10 | 7.69 |
| 1-octen-3-ol | 3.38 | 11.70 | 9.15 |
| Linalool oxide (trans) | 62.27 | 117.28 | 84.45 |
| EE-2,4-heptadienal | 23.14 | 49.85 | 37.90 |
| Benzaldehyde | 34.78 | 103.28 | 94.05 |
| Linalool | 127.83 | 169.89 | 119.87 |
| Phenylacetaldehyde | 34.23 | 145.18 | 85.18 |
| Linalool oxide (3) | 13.82 | 53.80 | 35.27 |
| a-terpineol | trace | 4.83 | 3.12 |
| Linalool oxide (4) | 13.99 | 23.48 | 24.98 |
| Me salicylate | 48.22 | 51.67 | 40.98 |
| EE-2,4-Decadiennal | 28.64 | 10.76 | 11.29 |
| geraniol | 98.89 | 142.95 | 110.09 |
| benzyl alcohol | 20.75 | 23.79 | 21.90 |
| 2-phenylethanol | 27.30 | 66.49 | 55.80 |
| β-ionone | 26.05 | 92.39 | 78.24 |
| nerolidol | 54.25 | 572.06 | 384.68 |
| methyl jasmonate | 15.33 | 18.59 | 16.51 |
| indole | 27.22 | 359.89 | 248.01 |

It was found that the characteristic oolong markers indole, nerolidol, phenylacetaldehyde and B-ionone were not significantly depressed when the solar wither was absent. Perhaps more importantly, the oolong black tea without solar wither gave a beverage which had comparable floral aroma to the oolong black tea with a solar wither step.

1. A process for making black or green tea, comprising the steps of
(i) obtaining a source of tea plant material;
(ii) processing the tea in one or more of the following conventional black and green tea unit operations: steaming, rolling, drying, maceration, withering, fermenting, drying; characterised in that the process also involves tumbling said leaves so as to induce physical wounding of the leaves but does not involve a light-induced withering step, and wherein the leaves are not frozen before or during the tumbling.

2. A process according to claim 1, wherein the leaves are tumbled at least twice, preferably at least three times.

3. A process according to claim 1, wherein the leaves are left to wither indoors for at least 2 hours.

4. A process according to claim 3, wherein the tumbling takes place during the indoor wither.

5. A process according to claim 3, wherein the leaves are macerated after the long wither.

6. A process according to claim 1 wherein the temperature of the leaves during tumbling is between 5 and 40° C.
